(19) United States
(12) Patent Application Publication
(10) Pub. No.: US 2022/0413353 A1
(43) Pub. Date: Dec. 29, 2022

(54) Combinatorial Optimization Problem Processor and Method

(71) Applicant: Nippon Telegraph and Telephone Corporation, Tokyo (JP)

(72) Inventor: Toshiya Sato, Musashino-shi, Tokyo (JP)

(21) Appl. No.: 17/787,659

(22) PCT Filed: Dec. 23, 2019
(86) PCT No.: PCT/JP2019/050350

§ 371 Date: Jun. 21, 2022

(51) Int. Cl. G02F 1/21

(52) U.S. Cl. CPC G02F 1/212

(57) ABSTRACT

A differential phase modulation Mach-Zehnder optical modulator includes a first phase modulation unit and a second phase modulation unit; an optical interference circuit that receives a polarized clock pulse train that was modulated by the differential phase modulation Mach-Zehnder optical modulator, and allows a predetermined interaction in the Ising model to occur at a period corresponding to the N pulses of the polarized clock pulse train; and a multiplexer/demultiplexer that receives the N initialization optical pulses that create a neutral state with respect to interactions between the elements and receives an output light pulse train from the optical interference circuit, couples the initialization optical pulses with output of the optical interference circuit, demultiplexes the initialization optical pulses and the output light pulse train, outputs a demultiplexed first phase modulation signal to the first phase modulation unit, and outputs a demultiplexed second phase modulation signal to a delay unit.

### TECHNICAL FIELD

The present invention relates to a combinatorial optimization problem processing device and method for deriving a solution to a combinatorial optimization problem.

### BACKGROUND ART

A combinatorial optimization problem involves finding a combination of parameters (i.e., a solution) that maximizes (or minimizes) an evaluation index under given conditions. Combinatorial optimization problems can be applied to situations where better selections are required in various fields such as delivery and drug discovery.

In an NP-hard class combinatorial optimization problem, the number of combinations increases exponentially as the number of elements (number of parameters) N in the combination increases, and therefore the fact that finding an optimal solution with a “brute-force method” takes an unrealistic long time has been an issue.

Study is underway to find a solution for this issue. It is known that there is a correspondence between solving a combinatorial optimization problem and finding the most stable energy state of an Ising model. In view of this, in NPL 1 for example, there is a technique for finding the most stable state in an Ising model by a method based on simulated annealing, and this technique is implemented in a CMOS semiconductor chip, simulation is performed, and the most stable energy state is found in order to substantially solve a combinatorial optimization problem.

### CITATION LIST

### Non Patent Literature

[NPL 1] Masanao Yamaoka, et al., “CMOS Ising Computer to Help Optimize Social Infrastructure Systems”, Hitachi Review, Vol. 99, No. 03, 328-329.

### SUMMARY OF THE INVENTION

### Technical Problem

However, this conventional method has a problem that finding an optimal solution is time-consuming.

The present invention has been made in view of the foregoing issues, and an object of the present invention is to provide a combinatorial optimization problem processing device and method for finding an optimal solution to a combinatorial optimization problem in a short time.

### Means for Solving the Problem

A combinatorial optimization problem processing device according to an aspect of the present invention is a combinatorial optimization problem processing device for associating a combinatorial optimization problem having N elements with an Ising model to process the combinatorial optimization problem, the combinatorial optimization problem processing device including: a differential phase modulation Mach-Zehnder optical modulator that is configured to receive a polarized clock pulse train, and includes a first phase modulation unit and a second phase modulation unit; an optical interference circuit configured to receive a polarized clock pulse train that was modulated by the differential phase modulation Mach-Zehnder optical modulator, allow a predetermined interaction in the Ising model to occur at a period corresponding to the N pulses of the polarized clock pulse train, and externally output a monitor signal that represents a solution to the optimization problem; a multiplexer/demultiplexer configured to receive the N initialization optical pulses that create a neutral state with respect to interactions between the elements and receive an output light pulse train from the optical interference circuit, couple the initialization optical pulses with output of the optical interference circuit, demultiplex the initialization optical pulses and the output light pulse train, output a demultiplexed first phase modulation signal to the first phase modulation unit, and output a demultiplexed second phase modulation signal to a delay unit; and the delay unit configured to delay the second phase modulation signal and output the delayed second phase modulation signal to the second phase modulation unit, wherein the delay unit delays the second phase modulation signal relative to the first phase modulation signal by a time that is greater than or equal to a pulse width of pulses of the polarized clock pulse train and less than one period.

Also, a combinatorial optimization problem processing method according to an aspect of the present invention is a combinatorial optimization problem processing method performed by the above-described combinatorial optimization problem processing device, the method including: a Mach-Zehnder optical modulation step of a differential phase modulation Mach-Zehnder optical modulator, which includes a first phase modulation unit and a second phase modulation unit, modulating a polarized clock pulse train; an optical interference step of receiving a polarized clock pulse train that was modulated in the Mach-Zehnder optical modulation step, allowing a predetermined interaction in the Ising model to occur at a period corresponding to the N pulses of the polarized clock pulse train, and externally outputting a monitor signal that represents a solution to the optimization problem; a multiplex/demultiplex step of receiving the N initialization optical pulses that create a neutral state with respect to interactions between the elements and receiving an output light pulse train from an optical interference circuit, coupling the initialization optical pulses with output of the optical interference circuit, demultiplexing the initialization optical pulses and the output light pulse train, outputting a demultiplexed first phase modulation signal to the first phase modulation unit, and outputting a demultiplexed second phase modulation signal to a delay unit; and a delay step of delaying the second phase modulation signal and outputting the delayed second phase modulation signal to the second phase modulation unit, wherein in the delay step, the second phase modulation signal is delayed relative to the first phase modulation signal by a time that is greater than or equal to a pulse width of pulses of the polarized clock pulse train and less than one period.

### Effects of the Invention

According to the present invention, an optimal solution to a combinatorial optimization problem can be found in a short time.

### BRIEF DESCRIPTION OF DRAWINGS

FIG. 1 is a diagram showing an Ising model.

FIG. 2 is a diagram schematically showing an example of a combinatorial optimization problem.

FIG. 3 is a diagram showing an example of a functional configuration of a combinatorial optimization problem processing device according to a first embodiment of the present invention.

FIG. 4 is a diagram showing relationships between series of a polarized clock pulse train.

FIG. 5 is a diagram showing a specific example of a configuration of an optical interference circuit shown in FIG. 3.

FIG. 6 is a diagram showing a specific example of a configuration of a differential phase modulation Mach-Zehnder optical modulator shown in FIG. 3.

FIG. 7 is a diagram showing relationships between N initialization pulses, a first phase modulation signal, a second phase modulation signal, and a polarized clock pulse train.

FIG. 8 is a diagram showing an optical interference circuit included in a combinatorial optimization problem processing device 200 according to a second embodiment of the present invention.

FIG. 9 is a diagram showing results of a demonstration experiment in which a combinatorial optimization problem was solved using the combinatorial optimization problem processing device shown in FIG. 3.

### DESCRIPTION OF EMBODIMENTS

Before describing embodiments of the present invention, the following briefly describes an Ising model and a combinatorial optimization problem.

### Ising Model

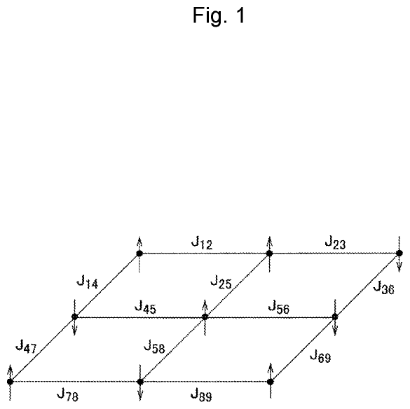

FIG. 1 shows an Ising model. An Ising model is a statistical mechanics model that represents the properties of magnetic materials (ferromagnets, antiferromagnets, etc.). It is made up of lattice points that take either up or down spin states, and becomes stable when the energy H is the lowest in consideration of interactions between adjacent lattice points.

In numerical calculation performed using a method such as a neural network, an Ising model is expressed by spin states σᵢ of the lattice points, interaction coefficients Jᵢⱼ that represent the strength of interactions between pairs of spin states, and external magnetic field coefficients hi that represent the strength of an externally applied magnetic field. The energy H of the Ising model can be expressed by the following expression.

$$\begin{matrix}Math . 1 & \\ H = - {\sum }_{〈 i , j 〉} {J}_{ij {σ}_{i} {σ}_{j}} - {\sum }_{j} {h}_{j} {σ}_{j} & ( 1 )\end{matrix}$$

In the Ising model, the spin states are shifted until the energy H is minimized. By mapping a problem such that the evaluation index of the combinatorial optimization problem corresponds to the energy of an Ising model and then allowing the Ising model to converge, it is possible to find a combination of spin states that minimizes the energy. In other words, this means finding a combination of parameters that minimizes the evaluation index of the original optimization problem.

Note that optimization simulators commonly called Ising model machines have been extended to consider interactions not only between adjacent lattice points but also between all lattice points.

### Combinatorial Optimization Problem

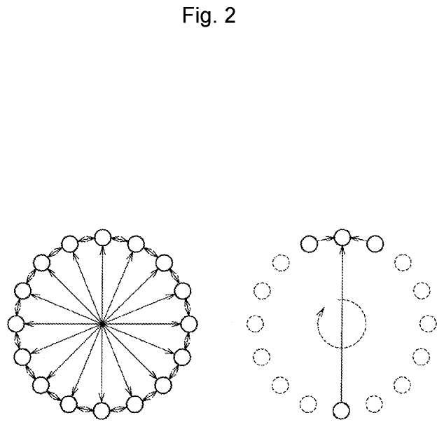

FIG. 2 is a diagram schematically showing an example of a combinatorial optimization problem called a Max-Cut-3 problem with N=16. The circles shown in FIG. 2 represent the N=16 elements.

A Max-Cut-3 problem is a problem of maximizing the total weight of cut edges when elements are grouped into two groups. Here, “3” means the number of interactions in the Ising model.

The right side of FIG. 2 is a diagram schematically showing interactions. The figure on the right side shows an example of interacting with three elements, namely the elements directly ahead and behind (±1) and the element eight places ahead (+8). Note that the interactions in a Max-Cut-3 problem with N=16 are not limited to this example.

Combinatorial optimization problem processing devices according to embodiments of the present invention will be described below by way of example of solving the combinatorial optimization problem shown in FIG. 2. Hereinafter, embodiments of the present invention will be described with reference to the drawings. Like reference numerals denote like objects in the drawings, and redundant descriptions will not be given.

### First Embodiment

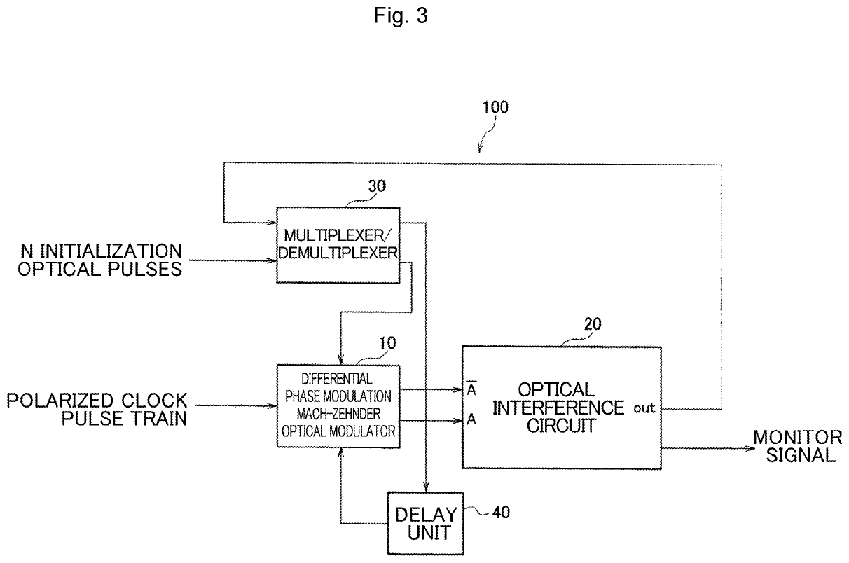

FIG. 3 is a diagram showing an example of the functional configuration of a combinatorial optimization problem processing device according to a first embodiment of the present invention. A combinatorial optimization problem processing device 100 shown in FIG. 3 includes a differential phase modulation Mach-Zehnder optical modulator 10, an optical interference circuit 20, a multiplexer/demultiplexer 30, and a delay unit 40.

The differential phase modulation Mach-Zehnder optical modulator 10 includes a first phase modulation unit and a second phase modulation unit, and is the same as the Mach-Zehnder interference optical intensity modulator MZ-1 described in Japanese Patent No. 5632330. The specific configuration of the differential phase modulation Mach-Zehnder optical modulator 10 will be described later.

The differential phase modulation Mach-Zehnder optical modulator 10 receives a polarized coherent clock pulse train (hereinafter, the term “coherent” will be omitted). The Mach-Zehnder optical modulator 10 adjusts a fixed phase condition such that the following expression holds.

Math. 2

ø_{i+N}=sin²(πøᵢ) (2)

A polarized clock pulse train that was modulated by the differential phase modulation Mach-Zehnder optical modulator 10 and output from A, A⁻, or both is input to the optical interference circuit 20. Note that the correct notation for A⁻ is shown in FIG. 3, and the same applies hereinafter. Also, hereinafter, the term “modulation” will be omitted, and the differential phase modulation Mach-Zehnder optical modulator 10 will be called the “differential phase Mach-Zehnder optical modulator 10”.

Here, in the present embodiment, each pulse i of the polarized clock pulse train corresponds to one element of the combinatorial optimization problem. Accordingly, a set of N=16 pulses according to Expression 2 can be regarded as one series.

Here, there are N series, namely i, i+N, i+2N, . . . as one series, (i+1), (i+1)+N, (i+1)+2N, . . . as another series, (i+(N−1)), (i+(N−1))+N, (i+(N−1))+2N, . . . as another series, and so on.

By allowing the above-described interaction between the pulse trains of each series, it is possible to realize the combinatorial optimization problem processing device 100 that solves the Max-Cut-3 problem with N=16, for example.

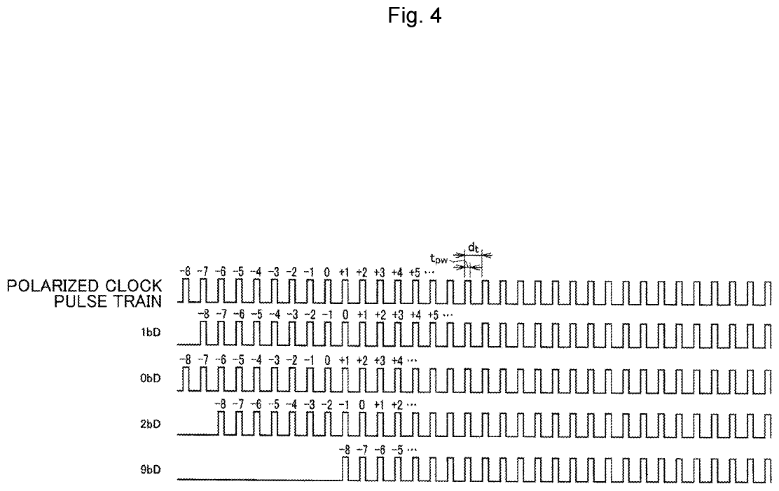

FIG. 4 is a time chart illustrating relationships between series. In FIG. 4, the horizontal direction represents time, the first line in the vertical direction is the polarized clock pulse train input to A⁻ of the optical interference circuit 20 for example, the second line is a pulse train lbd resulting from the polarized clock pulse train of the first line being delayed by one polarized clock pulse, the third line is a pulse train 0 bd that is the non-delayed polarized clock pulse train of the first line, the fourth line is a pulse train 2 bd resulting from the polarized clock pulse train of the first line being delayed by two polarized clock pulses, and the fifth line is a pulse train 9 bd resulting from the polarized clock pulse train of the first line being delayed by nine polarized clock pulses. Note that for the purpose of making the description easier to understand, identification numbers −8, −7, −6, . . . , −1, 0, +1, +2, +3, . . . are assigned from the left side of the polarized clock pulse train.

Let us now focus on the 17th pulse with the identification number 0, which is the pulse i of the pulse train 1 bd that has been cycled by 16 pulses. The pulse with the identification number 0 is the first pulse in terms of the period of N pulses.

The pulse numbers of the pulses at the same timing as this first pulse in the other pulse trains 0 bD, 2 bD, and 9 bD are respectively +1, −1, and −8. In other words, the timing of the pulse with identification number 0 matches the timing of the +1 pulse that is one pulse ahead, the −1 pulse i=18 (16th) that is two pulses behind, and the −8 pulse that is eight pulses behind.

By allowing interference between these polarized pulses in the optical interference circuit 20, interaction Q_{AF} expressed by the following expression can occur.

Math. 3

Q_{AF:i}=−Σ^{i≠k}J_{i:k}(\sqrt{øᵢ}−{square root over (1−øᵢ₊ₖ))}) (3)

Here, i is the serial number of the pulses that make up the polarized clock pulse train, k is a number representing the position of the pulse among the N pulses, and J_{i:k} is a coefficient representing the magnitude of the interaction. Note that the second term in (⋅) on the right side of Expression 3 corresponds to the other A⁻ output of the differential phase Mach-Zehnder optical modulator 10. Expression 3 represents an antiferromagnetic interaction.

Note that in the above example, there is more than one k. For example, k=+1, k=−1, and k=+8. The values of k correspond to the interactions shown in the right figure of FIG. 3.

The power of the polarized clock pulse train output by the optical interference circuit 20 can be expressed by the following expression.

Math. 4

ø_{i+N}=sin²π|\sqrt{øᵢ}−Q_{AF:i}|² (4)

In this way, if the output light pulses derived from the polarized clock pulse train from the differential phase Mach-Zehnder optical modulator 10 are input to the optical interference circuit 20, it is possible to generate a polarized clock pulse train influenced by desired interaction.

### Optical Interference Circuit

The optical interference circuit 20 receives a polarized clock pulse train that was modulated by the differential phase Mach-Zehnder optical modulator 10, and allows predetermined interactions in the Ising model to occur at a period corresponding to the N pulses of the polarized clock pulse train and externally outputs a monitor signal that represents a solution to the combinatorial optimization problem.

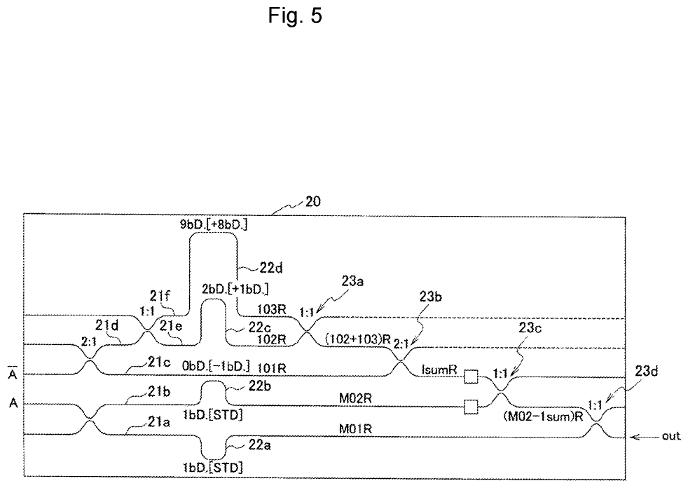

FIG. 5 is a diagram showing a specific example of the optical interference circuit 20. As shown in FIG. 5, the optical interference circuit 20 includes a plurality of delay units including a first delay unit 22a, a second delay unit 22b, a third delay unit 22c, and a fourth delay unit 22d; a plurality of optical waveguides including a first main pathway 21a, a second main pathway 21b, a first action pathway 21c, a second action pathway 21e, and a third action pathway 21f; and a plurality of optical couplers including a first optical coupler 23a, a second optical coupler 23b, a third optical coupler 23c, and a fourth optical coupler 23d.

The first delay unit 22a receives one polarized clock pulse train branched from the one polarized clock pulse train A that was modulated by the differential phase Mach-Zehnder optical modulator 10, and delays the polarized clock pulse train in units of pulses. In this example, the first delay unit 22a delays the polarized clock pulse train by one pulse. The first main pathway 21a propagates the first polarized clock pulse train 1 bD that was delayed by one pulse in the first delay unit 22a.

The second delay unit 22b receives the other polarized clock pulse train branched from the one polarized clock pulse train A that was output by the differential phase Mach-Zehnder optical modulator 10, and delays the polarized clock pulse train by the same number of pulses as the first delay unit. The second main pathway 21b propagates the first polarized clock pulse train 1 bD that was delayed by the same number of pulses as the first delay unit.

The first action pathway 21c receives one third polarized clock pulse train 0 bD that was branched from the other polarized clock pulse train A⁻ that was modulated by the differential phase Mach-Zehnder optical modulator 10, and propagates the third polarized clock pulse train 0 bD as it is.

The third delay unit 22c receives one polarized clock pulse train branched from the other polarized clock pulse train A⁻ that was output by the differential phase Mach-Zehnder optical modulator 10, and delays the polarized clock pulse train in units of pulses. In this example, the third delay unit 22c delays the polarized clock pulse train by two pulses. The second action pathway 21e propagates the fourth polarized clock pulse train 2 bD, which is the result of the one polarized clock pulse train branched from the polarized clock pulse train A⁻ being delayed by two pulses.

The fourth delay unit 22d receives the one polarized clock pulse train branched from the polarized clock pulse train A⁻, and delays the polarized clock pulse train in units of pulses. In this example, the fourth delay unit 22d delays the polarized clock pulse train by nine pulses. The third action pathway 21f propagates the fifth polarized clock pulse train 9 bD, which is the result of the other polarized clock pulse train branched from the polarized clock pulse train A⁻ being delayed by nine pulses.

The first optical coupler 23a allows interference such that the amplitudes of the optical signals of the third action pathway 21f and the second action pathway 21e are added. The second optical coupler 23b allows interference such that the amplitudes of the output optical signal of the first optical coupler 23a and the optical signal of the first action pathway 21c are added.

The third optical coupler 23c allows interference such that the amplitudes of the output optical signal of the second optical coupler 23b and the optical signal of the second main pathway 21b are subtracted.

The fourth optical coupler 23d allows interference such that the amplitudes of the output optical signal of the third optical coupler 23c and the optical signal of the first main pathway 21a are subtracted. The signal output from the terminal of the fourth optical coupler 23d not labeled “out” is the monitor signal. The monitor signal represents a solution to the optimization problem. A specific example of a solution will be described later.

According to the optical interference circuit 20 described above, the interactions shown in the right figure of FIG. 3 can occur. By changing the combination of delay amounts of the first to fourth delay units 22a to 22d, it is also possible to allow interactions between different combinations of elements.

In the present embodiment, a neutral state, in which the magnitude of the relationships between the elements is not biased, is produced before the above-mentioned interactions are allowed to occur. The neutral state is produced by the N initialization optical pulses.

### Differential Phase Mach-Zehnder Optical Modulator

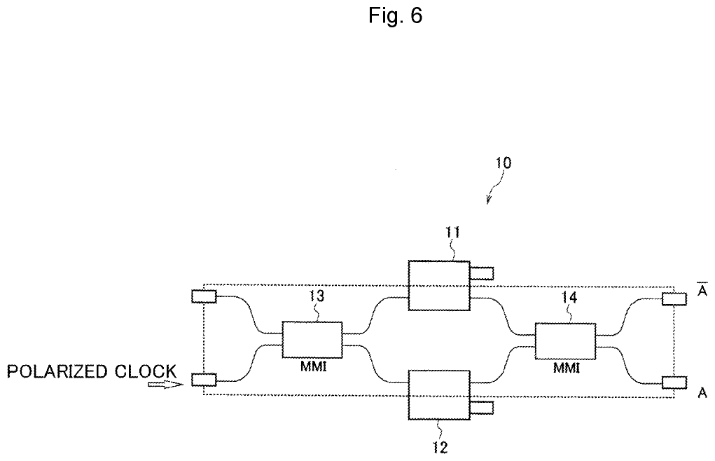

FIG. 6 is a diagram showing the configuration of the differential phase Mach-Zehnder optical modulator 10. As shown in FIG. 6, the differential phase Mach-Zehnder optical modulator 10 includes two MMIs (multimode interference units) 13 and 14, a first phase modulation unit 11, and a second phase modulation unit 12.

Under the phase condition of the basic state of the differential phase Mach-Zehnder optical modulator 10, the polarized clock pulse train input to the MMI 13 is output from the output A⁻ of the MMI 14. At this time, if a modulation signal that shifts the foregoing phase condition by exactly π is input to the first phase modulation unit 11, the state switches such that the polarized clock pulse train is output from the output A of the MMI 14, and the differential phase Mach-Zehnder optical modulator 10 enters the open state. When a modulation signal that pulls the phase condition back by exactly η is input to the second phase modulation unit 12, the state is pulled back such that the polarized clock pulse train is output from the output A⁻ of the MMI 14, and the differential phase Mach-Zehnder optical modulator 10 returns to the closed state.

In other words, the differential phase Mach-Zehnder optical modulator 10 enters the open state when a modulation signal is input to the first phase modulation unit 11, and enters the closed state when a modulation signal is input to the second phase modulation unit 12. The configuration and operation of the differential phase Mach-Zehnder optical modulator 10 is described in Japanese Patent No. 5632330. A further description will not be given.

The multiplexer/demultiplexer 30 receives the N initialization optical pulses that create a neutral state for interactions between the elements and the output light pulse train of the optical interference circuit 20, and provides two outputs for either one of the above inputs, namely one output as a drive signal for the first phase modulation unit 11, and another output given to the delay unit 40 as a drive signal for the second phase modulation unit 12.

The drive signal delayed by the delay unit 40 is output to the second phase modulation unit 12.

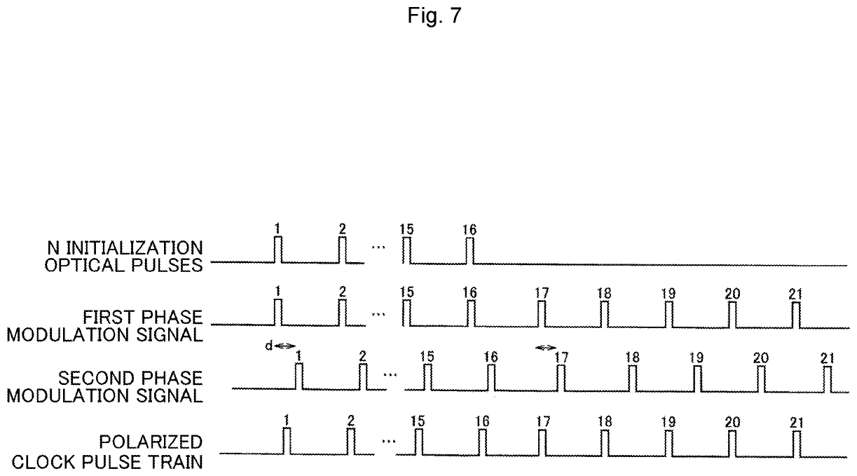

FIG. 7 is a diagram showing relationships between the N initialization pulses, the first phase modulation signal, the second phase modulation signal, and the polarized clock pulse train. Note that FIG. 7 only shows the timings of such signals, and the shown amplitudes have no significance.

As shown in FIG. 7, the second phase modulation signal that has been delayed by the delay unit 40 relative to the first phase modulation signal modulates the phase of the differential phase modulation Mach-Zehnder optical modulator 10 at a timing that is delayed by the delay time d.

When the first phase modulation signal and the second phase modulation signal are input in this way, the differential phase Mach-Zehnder optical modulator 10 enters the open state for the delay time d. When the polarized clock pulse train is input during this open state, the differential phase modulation Mach-Zehnder optical modulator 10 outputs, to the optical interference circuit 20, differential phase modulation output that corresponds to the power of the initialization signal and the return signal.

The first phase modulation signal and the second phase modulation signal switch to the polarized clock pulse train after the N initialization optical pulses. Accordingly, the first phase modulation from the i=17 pulse and onward matches the timing of the polarized clock pulse.

The delay time d is a time that is greater than or equal to the pulse width t_{pw} of the pulses of the polarized clock pulse train and sufficiently smaller than the pulse interval.

When the polarized clock pulse train is input to the optical interference circuit 20 at this timing, a neutral state (symmetric state) is produced in which the magnitude of the relationships between elements is 0 for each series of N=16 pulses. Thereafter, the previously described interactions occur in the optical interference circuit 20, and thus a phenomenon occurs in which symmetry is broken and a stable state emerges in the Ising model.

In this way, the solution to the combinatorial optimization problem can be found by reading the state that corresponds to the “Ising model in a stable state” that appears due to an emergent phenomenon beyond commonly-called reductionist understanding. The state that corresponds to the “Ising model in a stable state” is obtained by observing the monitor signal output from the optical interference circuit 20.

### Second Embodiment

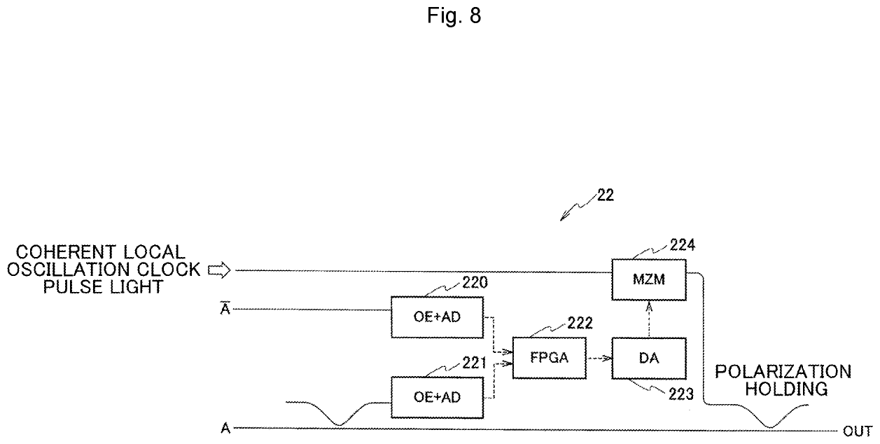

FIG. 8 is a diagram showing an optical interference circuit included in a combinatorial optimization problem processing device 200 according to a second embodiment of the present invention. The combinatorial optimization problem processing device 200 is not illustrated.

FIG. 8 shows the case where the optical interference circuit 20 includes an FPGA and a differential phase Mach-Zehnder optical modulator. The optical interference circuit 22 shown in FIG. 8 includes a photoelectric AD converter 220, a photoelectric AD converter 221, an FPGA 222, a DA converter 223, and a differential phase Mach-Zehnder optical modulator 224.

The photoelectric AD converter 220 performs AD conversion on an electric pulse signal obtained by photoelectrically converting the polarized clock pulse train A⁻. The photoelectric AD converter 221 performs AD conversion on an electric pulse signal obtained by photoelectrically converting the polarized clock pulse train A.

The FPGA 222 performs digital processing for calculation of the above-described interactions (FIG. 2). The output signal of the FPGA 222 is subjected to DA conversion and connected to the modulation signal terminal of the differential phase Mach-Zehnder optical modulator 224.

The differential phase Mach-Zehnder optical modulator 224 uses the output signal of the FPGA 222 to perform intensity modulation on coherent local oscillation clock pulse light. The coherent local oscillation clock pulse light can be provide as a pulse train branched from the above-described polarized clock pulse train by a directional coupler (not shown).

The OUT terminal shown in FIG. 8 corresponds to the OUT terminal shown in FIG. 3. In other words, the optical interference circuit 22 shown in FIG. 8 has the same operation as the optical interference circuit 20 shown in FIG. 3. As described above, the optical interference circuit 22 can also be configured including a semiconductor integrated circuit such as an FPGA.

### Demonstration Experiment

A demonstration experiment was conducted for the purpose of confirming effects of the embodiments. In the demonstration experiment, the combinatorial optimization problem processing device 100 according to the first embodiment of the present invention was configured, a polarized clock pulse train having a total time width of up to 1 μs was used, and a Max-Cut-3 problem with N=16 (FIG. 2) was solved. Note that in this observation, the trial start time was 62.033 μs after the reference observation time.

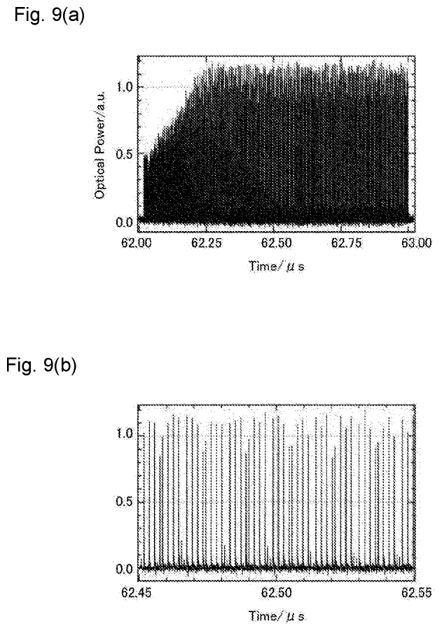

FIG. 9 is a diagram showing solution results of the demonstration experiment. The horizontal axis in FIG. 9 represents time (μs), and the vertical axis represents the power of the monitor signal (FIG. 3). FIG. 9(b) is an enlarged view of the range from 62.45 to 62.55 μs in FIG. 9(a).

The initialization optical pulse train was input at 62.033 μs. Immediately after the input of the initialization optical pulse train, the monitor signal shows a neutral state with a power of about 0.5. Thereafter, the monitor signal changes toward the stabilized state of the Ising model due to the influence of interactions produced by the optical interference circuit 20.

At 62.5 μs, the stable state is nearly achieved, and the 0/1 pattern of “0010101011010101” was obtained. This pattern is one optimal solution to the Max-Cut-3 problem with N=16.

In this way, the combinatorial optimization problem processing device 100 of the present embodiment can solve the Max-Cut-3 problem with N=16 in the short time of about 500 ns. It has been reported that the method of NPL 1 required a time of 672 μs.

As described above, according to the combinatorial optimization problem processing device 100 of the present embodiment, an optimal solution to a combinatorial optimization problem can be obtained in a short time.

The present invention is not limited to the above embodiments, and can be modified without departing from the scope of the gist of the invention. Although the Max-Cut-3 problem with N=16 has been illustrated as an example of a combinatorial optimization problem, the present invention is not limited to this example. The present invention can be applied to any combinatorial optimization problem as long as the combinatorial optimization problem can be mapped to correspond to energy states in an Ising model. Also, the interactions of the Max-Cut-3 problem with N=16 are not limited to the above example.

As described above, it goes without saying that the present invention includes various embodiments not described here. Accordingly, the technical scope of the present invention is defined only by invention specifying matter pertaining to a reasonable scope of patent claims based on the above description.

### REFERENCE SIGNS LIST

10 Differential phase modulation Mach-Zehnder optical modulator
20, 22 Optical interference circuit
30 Multiplexer/demultiplexer
40 Delay unit
100, 200 Combinatorial optimization problem processing device

1. A combinatorial optimization problem processing device for associating a combinatorial optimization problem having N elements with an Ising model to process the combinatorial optimization problem, the combinatorial optimization problem processing device comprising:
a differential phase modulation Mach-Zehnder optical modulator that is configured to receive a polarized clock pulse train, and includes a first phase modulation unit and a second phase modulation unit;
an optical interference circuit configured to receive a polarized clock pulse train that was modulated by the differential phase modulation Mach-Zehnder optical modulator, allow a predetermined interaction in the Ising model to occur at a period corresponding to the N pulses of the polarized clock pulse train, and externally output a monitor signal that represents a solution to the optimization problem;
a multiplexer/demultiplexer configured to receive the N initialization optical pulses that create a neutral state with respect to interactions between the elements and receive an output light pulse train from the optical interference circuit, couple the initialization optical pulses with output of the optical interference circuit, demultiplex the initialization optical pulses and the output light pulse train, output a demultiplexed first phase modulation signal to the first phase modulation unit, and output a demultiplexed second phase modulation signal to a delay unit; and
the delay unit configured to delay the second phase modulation signal and output the delayed second phase modulation signal to the second phase modulation unit,
wherein the delay unit delays the second phase modulation signal relative to the first phase modulation signal by a time that is greater than or equal to a pulse width of pulses of the polarized clock pulse train and less than one period.

2. The combinatorial optimization problem processing device according to claim 1,
wherein the optical interference circuit includes:
a first main pathway that includes a first delay unit configured to receive a first polarized clock pulse train that was branched from one polarized clock pulse train modulated by the differential phase modulation Mach-Zehnder optical modulator, and delay the first polarized clock pulse train in units of pulses of the first polarized clock pulse train,
a second main pathway that includes a second delay unit configured to receive a second polarized clock pulse train that was branched from the polarized clock pulse train, and delay the second polarized clock pulse train by the same number of pulses as the first delay unit,
a first action pathway configured to receive a third polarized clock pulse train that was branched from another polarized clock pulse train modulated by the differential phase modulation Mach-Zehnder optical modulator, and propagate the third polarized clock pulse train, and
a second action pathway that includes a third delay unit configured to receive a fifth polarized clock pulse train that was branched from a fourth polarized clock pulse train that was branched from the other polarized clock pulse train modulated by the differential phase modulation Mach-Zehnder optical modulator, and delay the fifth polarized clock pulse train in units of pulses of the fifth polarized clock pulse train.

3. The combinatorial optimization problem processing device according to claim 1,
wherein letting N be the number of elements, i be a serial number of each pulse of the polarized clock pulse train, J_{i:k} be a coefficient representing a magnitude of the predetermined interaction, and k be a number representing a position of a pulse among the N pulses that is different from i, the predetermined interaction Q_{AF} is expressed by the following expression, and
Q_{AF:i}=−Σ^{i≠k}J_{i:k}(\sqrt{øᵢ}−{square root over (1−øᵢ₊ₖ))}) Math. 5
a power of the polarized clock pulse train is expressed by the following expression.
ø_{i+N}=sin²π|\sqrt{øᵢ}−Q_{AF:i}|² Math. 6

4. A combinatorial optimization problem processing method performed by a combinatorial optimization problem processing device for associating a combinatorial optimization problem having N elements with an Ising model to process the combinatorial optimization problem, the combinatorial optimization problem processing method comprising:
a Mach-Zehnder optical modulation step of a differential phase modulation Mach-Zehnder optical modulator, which includes a first phase modulation unit and a second phase modulation unit, modulating a polarized clock pulse train;
an optical interference step of receiving a polarized clock pulse train that was modulated in the Mach-Zehnder optical modulation step, allowing a predetermined interaction in the Ising model to occur at a period corresponding to the N pulses of the polarized clock pulse train, and externally outputting a monitor signal that represents a solution to the optimization problem;
a multiplex/demultiplex step of receiving the N initialization optical pulses that create a neutral state with respect to interactions between the elements and receiving an output light pulse train from an optical interference circuit, coupling the initialization optical pulses with output of the optical interference circuit, demultiplexing the initialization optical pulses and the output light pulse train, outputting a demultiplexed first phase modulation signal to the first phase modulation unit, and outputting a demultiplexed second phase modulation signal to a delay unit; and
a delay step of delaying the second phase modulation signal and outputting the delayed second phase modulation signal to the second phase modulation unit,
wherein in the delay step, the second phase modulation signal is delayed relative to the first phase modulation signal by a time that is greater than or equal to a pulse width of pulses of the polarized clock pulse train and less than one period.

5. The combinatorial optimization problem processing device according to claim 2,
wherein letting N be the number of elements, i be a serial number of each pulse of the polarized clock pulse train, J_{i:k} be a coefficient representing a magnitude of the predetermined interaction, and k be a number representing a position of a pulse among the N pulses that is different from i, the predetermined interaction Q_{AF} is expressed by the following expression, and
Q_{AF:i}=−Σ^{i≠k}J_{i:k}(\sqrt{øᵢ}−{square root over (1−øᵢ₊ₖ))}) Math. 5
a power of the polarized clock pulse train is expressed by the following expression.
ø_{i+N}=sin²π|\sqrt{øᵢ}−Q_{AF:i}|² Math. 6
